(19) United States
(12) Patent Application Publication
(10) Pub. No.: US 2023/0386140 A1
(43) Pub. Date: Nov. 30, 2023

(54) SYSTEMS, METHODS, AND DEVICES FOR A VIRTUAL ENVIRONMENT REALITY MAPPER

(71) Applicant: Meetkai Inc., Marina Del Rey, CA (US)

(72) Inventors: Weili Dai, Las Vegas, NV (US); Anthony Sanchez, Marina Del Rey, CA (US); James Kaplan, Marina Del Rey, CA (US)

(21) Appl. No.: 18/202,102

(22) Filed: May 25, 2023

Related U.S. Application Data
(60) Provisional application No. 63/345,818, filed on May 25, 2022.

(51) Int. Cl. G06T 19/00

(52) U.S. Cl. CPC G06T 19/00

(57) ABSTRACT

Systems, devices, and methods including: generating a 3D virtual space for a given point of interest (POI); determining whether a set of user preferences are available within the generated 3D virtual space and customize the 3D virtual space based on the availability of the set of user preferences; determining a generated 3D environment based on the customized 3D virtual space and availability of the set of user preferences, wherein determining the generated 3D environment is further based on receiving data from a set of components; and updating the generated 3D environment to customize the 3D virtual space for a user based on receiving data from at least one of the components from the set of components, and wherein the set of components are being continuously executed in real-time thereby syncing the functions of a set of devices present in a virtual world environment with a set of devices present in a physical world environment.

### CROSS-REFERENCE TO RELATED APPLICATIONS

This application claims priority to and the benefit of U.S. Provisional Patent Application No. 63/345,818, filed May 25, 2022, the contents of which are hereby incorporated by reference herein for all purposes.

### TECHNICAL FIELD

The present invention relates generally to the field of virtual world environment to physical world environment reality mapper.

### BACKGROUND

In the field of virtual world environment and corresponding physical world environment the two environments are separate from each other, in that the digital augmentations of physical reality or augmented reality may not be mapped. Therefore, a common or a total immersion in virtual reality requires synchronization of the two environments in order to map reality to the virtual world environment, and vice versa.

### SUMMARY

A method embodiment may include: generating, by a computing device having a processor and addressable memory, a 3D virtual space for a given point of interest (POI); determining whether a set of user preferences are available within the generated 3D virtual space and customize the 3D virtual space based on the availability of the set of user preferences; determining a generated 3D environment based on the customized 3D virtual space and availability of the set of user preferences, where determining the generated 3D environment may be further based on receiving data from a set of components and executing at least one of: an Internet of Things (IoT) sync component, where the IoT sync component may be executed based on receiving physical/virtual input via checking for IoT input; an augmented reality sync component, where the augmented reality sync component may be executed based on receiving new augmented reality input via checking for augmented reality transmission data; a video/audio reality mapper transmission component, where the video/audio reality mapper transmission component may be executed based on receiving new video/audio transmission via checking for video/audio transmission data; a virtual and physical item sync component, where the virtual and physical item sync component may be executed based on receiving new virtual and physical item via checking for virtual and physical item data, where the virtual and physical item sync component may be further based on receiving data from at least one of: a mail transaction sync component, where the mail transaction sync component may be executed based on receiving new mail and third party data that comprise mail data based on checking for mail and third party data; and a third party transaction sync component, where the third party transaction sync component may be executed based on receiving new mail and third party data that comprise third party data based on checking for mail and third party data; a persona embodiment of physical reality component, where the persona embodiment of physical reality component may be executed based on if user setting for persona embodiment may be enabled via checking for embodiment notifications; updating the generated 3D environment to customize the 3D virtual space for a user based on the received data from at least one of the components from the set of components, and where the set of components are being continuously executed in real-time thereby syncing the functions of a set of devices present in a virtual world environment with a set of devices present in a physical world environment.

In additional method embodiments, the IoT sync component may be configured to provide a set of IoT devices that are remaining in sync between the virtual world environment and the physical world environment. In additional method embodiments, the augmented reality sync component may be configured to provide users in the physical world environment at a certain location, the ability to see users in the virtual world environment via AR lenses in the same location. In additional method embodiments, the video/audio reality mapper transmission may be configured to allow transmission of data from the physical world environment to the virtual world environment and vice versa.

In additional method embodiments, the virtual and physical item sync component may be configured to ensure virtual items in the virtual world environment and physical items in the physical world environment are properly in sync. In additional method embodiments, the virtual and physical item sync component may be configured to synchronize a virtual item and a physical item by ensuring that for a given virtual item, there may be a corresponding physical item and vice versa.

In additional method embodiments, the third party transaction sync component may be configured to create and synchronize transactions between the virtual world environment and the physical world environment. In additional method embodiments, the mail transaction sync component may be configured to synchronize mail transactions between the virtual world environment and the physical world environment. In additional method embodiments, the user mails a package of items in the virtual world environment and a package of the same items may be sent in the physical world environment.

In additional method embodiments, the persona embodiment of physical reality component may be configured to create a non-player character (NPC) that embodies physical reality. In additional method embodiments, user preferences are used to provide a customized 3D virtual space version of a physical POI that may be personalized to the user.

A computing device embodiment may include a processor and addressable memory, the processor configured to execute a set of components comprising: an Internet of Things (IoT) sync component, where the IoT sync component may be executed based on receiving physical/virtual input via checking for IoT input; an augmented reality sync component, where the augmented reality sync component may be executed based on receiving new augmented reality input via checking for augmented reality transmission data; a video/audio reality mapper transmission component, where the video/audio reality mapper transmission component may be executed based on receiving new video/audio transmission via checking for video/audio transmission data; a virtual and physical item sync component, where the virtual and physical item sync component may be executed based on receiving new virtual and physical item via checking for virtual and physical item data, where the virtual and physical item sync component may be further based on receiving data from at least one of: a mail transaction sync component, where the mail transaction sync component may be executed based on receiving new mail and third party data that comprise mail data based on checking for mail and third party data; and a third party transaction sync component, where the third party transaction sync component may be executed based on receiving new mail and third party data that comprise third party data based on checking for mail and third party data; a persona embodiment of physical reality component, where the persona embodiment of physical reality component may be executed based on if the user setting for persona embodiment may be enabled via checking for embodiment notifications; where the computing device may be further configured to: generate a 3D virtual space for a given point of interest (POI); determine whether a set of user preferences are available within the generated 3D virtual space and customize the 3D virtual space based on the availability of the set of user preferences; determine a generated 3D environment based on the customized 3D virtual space and availability of the set of user preferences, where the generated 3D environment may be further determined based on receiving data from the set of components being executed; and update the generated 3D environment to customize the 3D virtual space for a user based on the received data from at least one of the components from the set of components, and where the set of components are being continuously executed in real-time thereby to sync the functions of a set of devices present in a virtual world environment with a set of devices present in a physical world environment.

In additional computing device embodiments, the set of components further comprises: a component to group virtual aggregation for third party transactions. In additional computing device embodiments, the component to group virtual aggregation for third party transactions may be configured to take in a group of user preferences to create a transaction that may be an aggregate of all user preferences. In additional computing device embodiments, the component to group virtual aggregation for third party transactions may be connected to the third party transaction sync component to transmit the created transaction that may be an aggregate of all user preferences.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a high level functional block diagram of the different components within the reality mapper systems, devices, and methods;

FIG. 2 depicts a flow of the different component executions and data transmissions as part of the communication between components for the reality mapper embodiments;

FIG. 3 depicts a functional block diagram representing the different components in the reality mapper to generate a 3D space for a user;

FIG. 4 illustrates an example of a top-level functional block diagram of a computing device embodiment;

FIG. 5 is a high-level block diagram showing a computing system comprising a computer system useful for implementing an embodiment of the system and process;

FIG. 6 shows a block diagram of an example system in which an embodiment may be implemented;

FIG. 7 depicts an illustrative cloud computing environment, according to one embodiment;

FIG. 8 depicts a functional block diagram of the reality mapper system where the computing device is configured to generate a 3D space for a given POI;

FIG. 9 depicts a functional block diagram of the reality mapper system where the computing device is configured to provide an IoT Sync Module component;

FIG. 10 depicts a functional block diagram of the reality mapper system where the computing device is configured to provide an Augmented Reality Sync Module component;

FIG. 11 depicts a functional block diagram of a Video/Audio Reality Mapper Transmission component;

FIG. 12 depicts a functional block diagram of the Virtual < > Physical Item Sync Module component;

FIG. 13 depicts a functional block diagram of the reality mapper system for Group Virtual Aggregation for Third Party Transactions;

FIG. 14 depicts a functional block diagram of the reality mapper system to customize a POI space for a user;

FIG. 15 depicts a functional block diagram of a Third Party Transaction Sync Module component;

FIG. 16 depicts a functional block diagram of a Mail Service Transaction Sync Module component; and

FIG. 17 depicts a functional block diagram of a Persona Embodiment of Physical Reality component.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features. The described technology concerns one or more methods, systems, apparatuses, and mediums storing processor-executable process steps to execute a reality mapper that synchronizes between a virtual world and a physical world.

Virtual reality (VR) describes a computer-generated three-dimensional environment where users interact with objects or other users. In some VR related scenarios, users are placed inside an experience, where during the experience the system stimulates multiple senses, such as vision, hearing, and touch. Virtual reality may be experienced using headsets, which take over the user's vision to simulate the computer-generated three-dimensional environment, replacing the real-world with a virtual one. VR headsets may communicate with the system via a cable or wirelessly and include motion tracking sensors to track user movement, thus enabling a 360-degree world. VR headsets may also connect to smartphones which now provide an even more real-world experience using the smartphone's motion sensors and other built in sensors in conjunction with the VR headset.

Additionally, augmented reality is a subset of virtual reality that simulates artificial objects within the real-world, meaning the virtual objects interact with real-world objects. Using a smartphone camera, the system may superimpose additional information on top of the user's real-world environment. This process may also be experienced on a computer screen having the ability to display 3D objects or other such similar devices. Augmented reality may be as immersive as a virtual reality experience given that augmented reality builds an experience based on live surroundings. Augmented reality provides an enhanced version of the real physical world that is achieved through the use of digital visual elements, sound, or other sensory stimuli and often times uses mobile computing power for executing the code.

Augmented reality and virtual reality systems execute applications in which users immerse themselves into an alternate reality environment when wearing a head-mounted display that displays virtual and/or augmented reality user experiences. Accordingly, a computerized method for viewing an augmented reality environment comprises generating a unique environment corresponding to a user and rendering the unique environment on the user device for them to interact with. Such systems and methods utilize broadcasting of information formatted for reception by a user device. The broadcast information is based at least in part on the unique experiences for that user and certain preferences.

Embodiments of the present application provide a set of components to execute a series of steps to generate a 3D space in a virtual environment and experience. In one embodiment, the systems, methods, and devices for a reality mapper dynamically map a digital version of the real world location or interaction or both. That is, in one embodiment, for a given point of interest (POI), location based content and experiences may be mapped to physical world coordinates to create an environment where virtual and physical worlds may merge together. Some embodiments may utilize a given POI based on a defined specific physical location which a user may find interesting; other embodiments may include a non-public or even private environment rendered within the 3D space. Through customization, the POI and/or private space for a user may be customized based on user preferences.

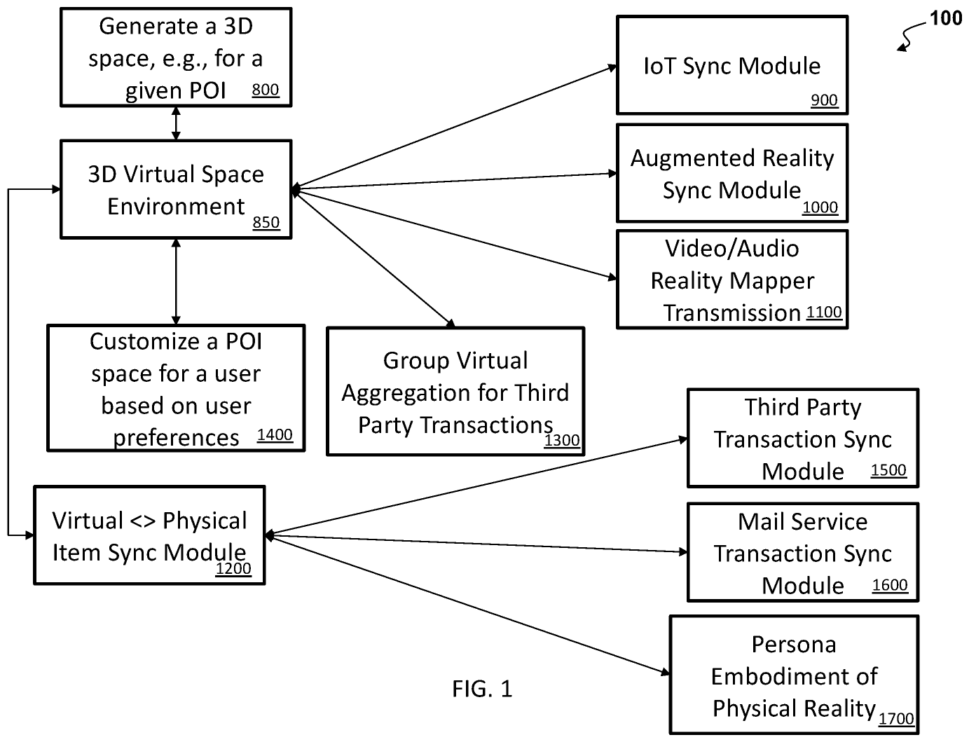

FIG. 1 depicts a high level functional block diagram of the different components within the reality mapper systems, devices, and methods. In some embodiments, the system initiates by executing a component to generate a 3D space, e.g., for a given POI 800, where a 3D virtual space environment 850 within the 3D generated space may provide a synchronization that may, for example, sync the functions of a set of devices present in the virtual world and a physical world via one or more Internet of Things (IoT) devices. In one embodiment, the POI may be a public place or private place in the physical world that maps to a virtual world and the system executes an IoT devices sync component, IoT Sync Module 900, for syncing between the virtual and physical world. Additionally, a video/audio reality mapper transmission component 1100 allows transmission of data from the physical world to the virtual world and vice versa. As part of the synchronization of the virtual world with the physical world, in another embodiment, users in the physical world at a certain location see users in the virtual world via, for example, AR lenses, in the same location. This embodiment may be executed by an augmented reality sync module component 1000 being executed by the system within the generated 3D space environment 850. The above embodiments for synchronizing devices, streaming media, and/or users across virtual world and physical work, may be executed individually or in combination and be part of a given POI or private 3D generated space. Accordingly, the reality mapper system components, e.g., 900, 1000, 1100, and 1200, function as components of a reality mapper system 100 that may be used in conjunction with each other and executed in parallel. In one example, the video transmission of a user in the physical world saying hello to a user in the virtual world may use the video/audio reality mapper transmission component 1100 and in another example, in conjunction with another component such as the IoT Sync Module 900. In the virtual world the user may be in a POI (e.g., house, street, restaurant or in nature) where the video transmission is to connect the physical and virtual in the same location. However, though the virtual location may be dependent on the POI generator, the video/audio reality mapper transmission component 1100 may transmit audio/video without the POI.

In some embodiments, once the 3D virtual environment is created, the different components disclosed herein continuously execute in the background and subsequent to a setup/creation of the space and initial mapping. Accordingly, the components may loop, i.e., execute a sequence of instructions that continually repeats until a certain condition is reached, for example, to check for new transmissions being received. That is, once the initial synchronization is determined, the system may constantly and continuously in real-time check for updates, that may be in the form of interactions or transmissions, and if not detected, continue to wait for such triggering events. For example, while waiting for any new transmissions, once any transmission is received, the system may execute the disclosed components to facilitate the transactions or interactions. In one embodiment, the initial synchronization is based on everything, i.e., an item, having a one-to-one or one-to-many relationships between the virtual world items and the physical world items.

In some embodiments, within the 3D generated space 850, the system may synchronize the availability of items between the virtual world and the physical world via executing a virtual < > physical item sync module component 1200. This component may synchronize a virtual and physical item by ensuring that for a given virtual item there is a corresponding physical item and vice versa. In one example, as part of the item synchronization, the system may confirm a particular item in the virtual world is available for purchase in the physical world in order to allow the user to perform a transaction to parallel them making a purchase or order. In particular, the system may execute transactions and synchronize them across the physical and virtual world via a third party transaction sync module component 1500, in order for the order to be made in the physical world and then also get delivered in the virtual world with a driver just like it does in the physical world. In addition, the system may execute a mail service transaction sync module component 1600 that synchronizes mail transactions between the virtual world and physical world where the user can mail a package of items in the virtual world and a package of the same items can be sent in the physical world.

In some embodiments, to further connect the virtual world with the physical world, the system may generate a non-player character (NPC) in the virtual world representing a physical object in the physical world. That is, a persona embodiment of physical reality component 1700 may transfer the character and function of an object in the physical world to a character (e.g., NPC) in the virtual world. Though this embodiment may not provide a one to one synchronization of character, the aspect of an object's function in the physical world may be presented in a character to provide similar features and functions.

In another embodiment, the system may use as input a group of user preferences and create a transaction that is an aggregate of all user preferences via a group virtual aggregation for a third party transactions component 1300. For example: a group of people who want to order food would receive a final order being something that all the users prefer based on the filtering performed using the user preferences.

Additionally, the generated 3D space for the POI may be customized via a Customize a POI space for a user based on user preferences component 1400. Hence, a customized version of a physical POI may be personalized to a user using a set of data associated with the user and collected over a period of time.

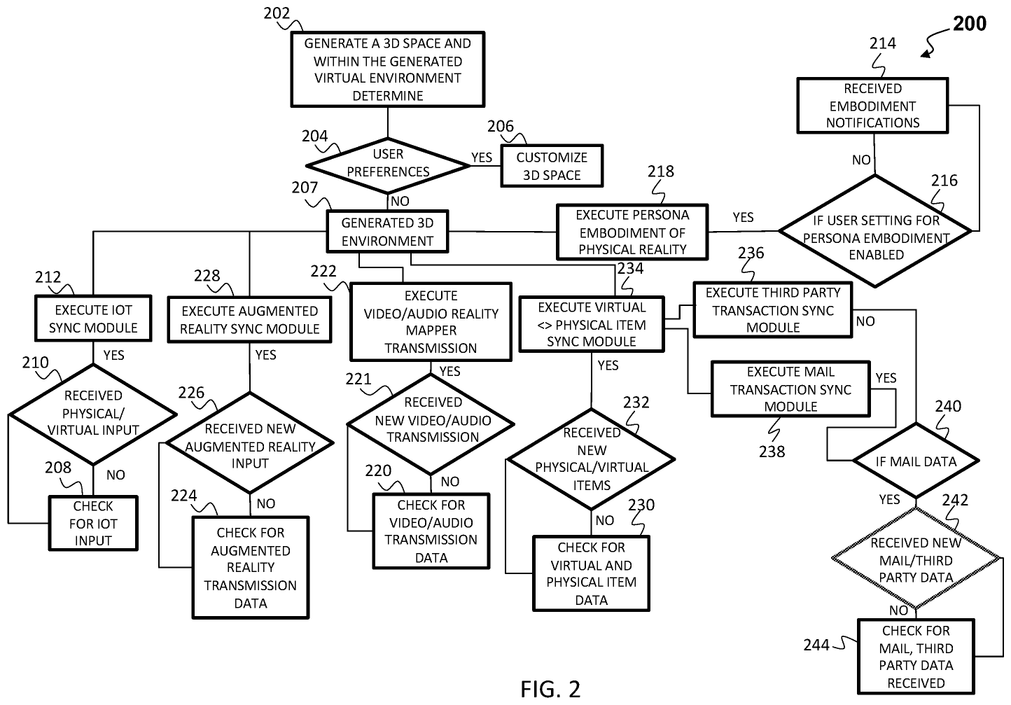

FIG. 2 depicts a flow of the different component execution and data transmission as part of the communication between components for the reality mapper embodiments 200. According to the disclosed embodiments, the reality mapper system is configured to generate a 3D space 202; customize the 3D space 206 if user preferences are received as input 204; based on a generated 3D environment 207, execute a number of components for the generated 3D environment. In one embodiment, the system may be configured to execute an IoT Sync Module 212 if it is determined that a set of IoT devices are present for synchronization based on received physical/virtual inputs 210, while continuously performing a check for IoT input 208. That is, the system may be configured to execute continuously and in the background, a check for IoT input 208 and if input is received, execute the IoT Sync Module 212, as described in more details below.

Continuing with FIG. 2, the system may use an augmented reality synchronization to execute an Augmented Reality Sync Module 228 if it is determined that augmented reality is present based on received new augmented reality input 226 for users and their devices from the virtual world with the physical world and vice versa, while continuously performing check for Augmented Reality transmission data 224. The system may also be configured to execute a Video/Audio Reality Mapper Transmission 222 as the system may continuously check for video/audio transmission data 220 to see if there is a need for synchronizing video/audio transmission and if the system received new video/audio transmission 221 between the virtual world and physical devices, such media is then transmitted via executing the Video/Audio Reality Mapper Transmission 222. The system may further be configured to execute a Persona Embodiment of Physical Reality 218 if the user setting for persona embodiment is enabled 216 and while continuously checking to see if the system has received embodiment notifications 214.

The system may further be configured to execute a Virtual < > Physical Item Sync Module component 234 if determined that a set of virtual and physical items are present, via continuously checking for virtual and physical item data 230, and if the system has received new virtual/physical items 232, then based on availability, execute a Virtual < > Physical Item Sync Module 234. In one embodiment, the Virtual < > Physical Item Sync Module component 234, where < > may indicate a to/from bidirectional communication, may be executed asynchronously in a separate process, or even in a separate location, and in a loop waiting for an event(s) to occur or a condition(s) to be met. Additionally, the system may be configured to continuously execute and in the background check for Mail/Third Party data being received 244 and if the system received new Mail/Third Party data 242, then the system determines if Mail Data 240 is present, to then execute Mail Transaction Sync Module component 238. The system may then transmit the synchronized mail transaction data to the Virtual < > Physical Item Sync Module 234 for processing. In another embodiment, if the system received new Mail/Third Party data 242 but not Mail Data 240, then the system may be configured to execute a Third Party Transaction Sync Module component 236 which then transmits the synchronized third party transaction data to the Virtual < > Physical Item Sync Module 234 for processing.

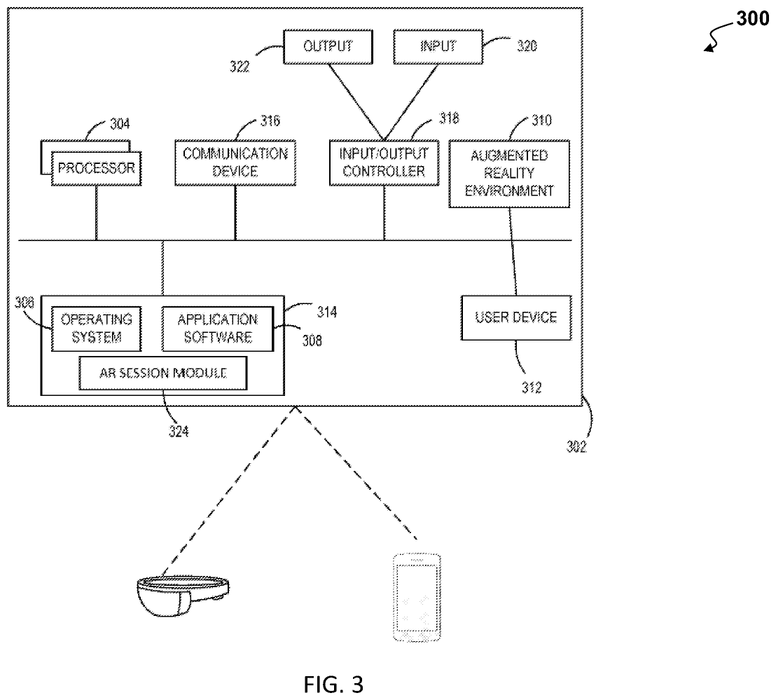

FIG. 3 depicts a functional block diagram representing the different components in the reality mapper to generate a 3D space for a user. In one embodiment, the 3D space may be generated based on a physical space by mapping the two spaces for a given POI. The disclosed embodiments may be operable with a computing apparatus 302 according to an embodiment as a functional block diagram 300. In one example, components of the computing apparatus 302 may be implemented as a part of an electronic device according to one or more embodiments described in this specification. The computing apparatus 302 may include one or more processors 304 which may be microprocessors, controllers, or any other suitable type of processors for processing computer executable instructions to control the operation of the electronic device, for example, via a communication device 316. Platform software comprising an operating system 306 or any other suitable platform software may be provided on the apparatus 302 to enable application software 308 to be executed on the device. According to an embodiment, viewing of an augmented reality environment 310 from a user device 312 may be executed by software running on a special machine. The computing apparatus 302 may further include an augmented reality (AR) session component 324. It should be noted that the AR session component 324 may be within one or more of the user device 312, such as a VR headset, or other components of the various examples. The AR session component 324 may be configured to perform operations or methods described herein, including, for example, to initialize, authenticate and/or join the user device 312 (e.g., smartphone or tablet) to the VR headset operating as an augmented reality device. An addressable memory 314 may store, among other data, one or more applications or algorithms that include data and executable instructions. The applications, when executed by the processor, operate to perform functionality on the computing device. Examples of different applications include augmented reality applications and/or components, such as the AR session component 324, for example.

In some examples, the computing apparatus 302 detects voice input, user gestures or other user actions and provides a natural user interface (NUI). This user input may be used to author electronic ink, view content, select ink controls, play videos with electronic ink overlays and for other purposes. The input/output controller 318 outputs data 322 to devices other than a display device in some examples, e.g. a locally connected printing device. NUI technology enables a user to interact with the computing apparatus 302 in a natural manner, free from artificial constraints imposed by input devices 320 such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

The above apparatus may provide the system by which users and systems can map where someone is in the virtual world, to a place in the real world which does not have a one-to-one mapping. Additionally, an environment where someone is in the real world uses devices and QR codes in the real world to help augment that system.

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

FIGS. 1-17 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

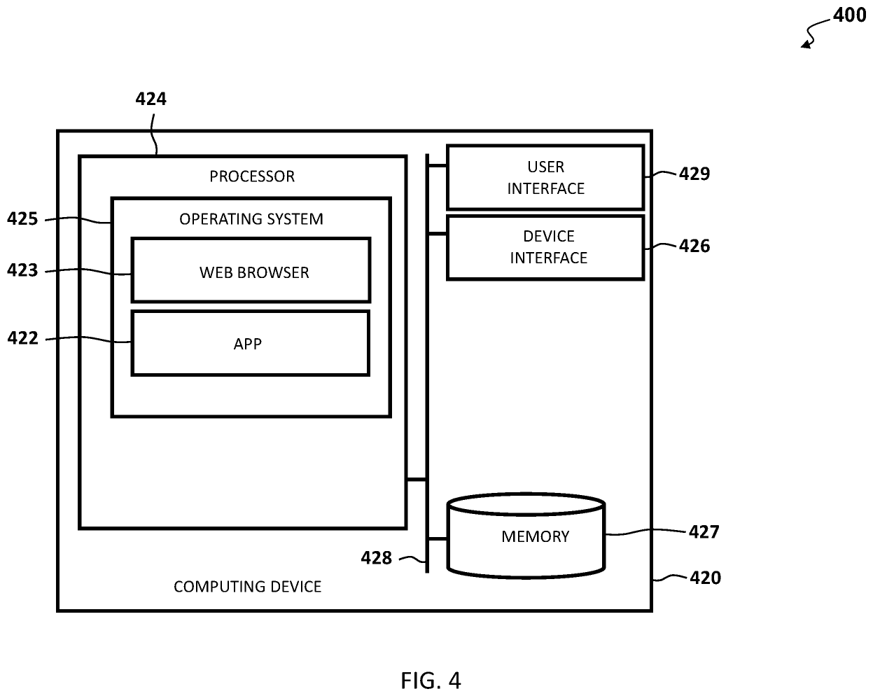

FIG. 4 illustrates an example of a top-level functional block diagram of a computing device embodiment 400. The example operating environment is shown as a computing device 420 comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 420, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above.

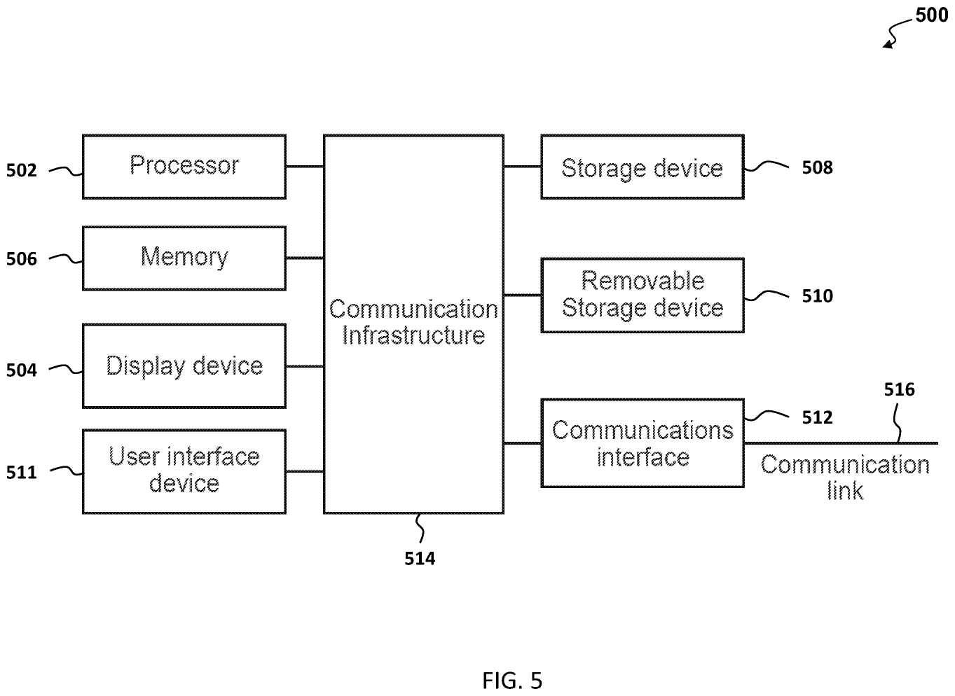

FIG. 5 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by a communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

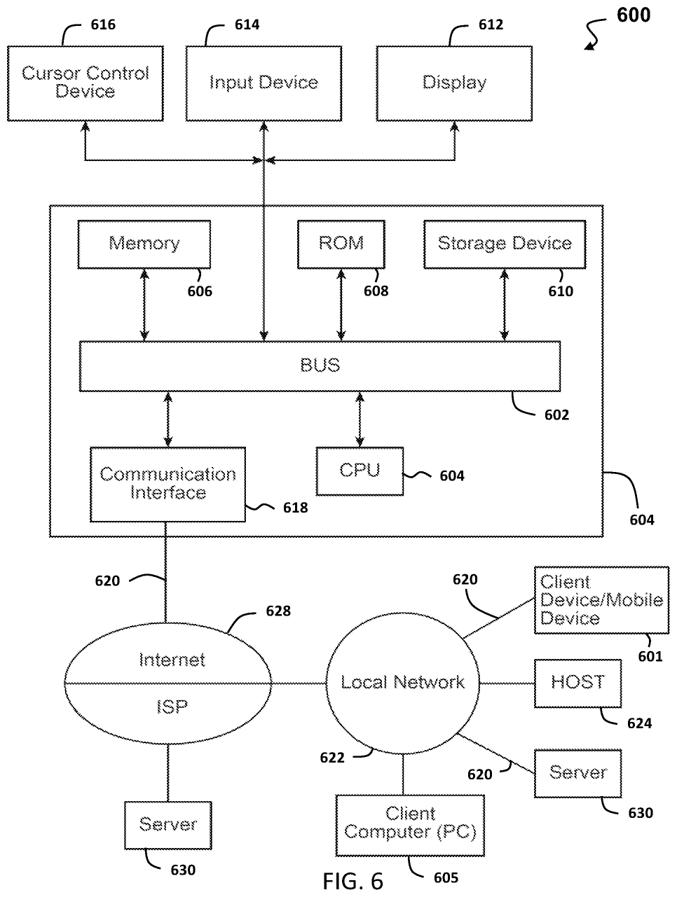

FIG. 6 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic, or optical signals that carry digital data streams. The signals through the various networks and the signals on the network link 620 and through the communication interface 618, which carry the digital data to and from the server 630, are example forms of carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic, or optical signals that carry digital data streams. The signals through the various networks and the signals on the network link 620 and through the communication interface 618, which carry the digital data to and from the server 630, are example forms of carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data, and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630. The system 600 can further include computers (e.g., personal computers, computing nodes) 605 operating in the same manner as client devices 601, where a user can utilize one or more computers 605 to manage data in the server 630.

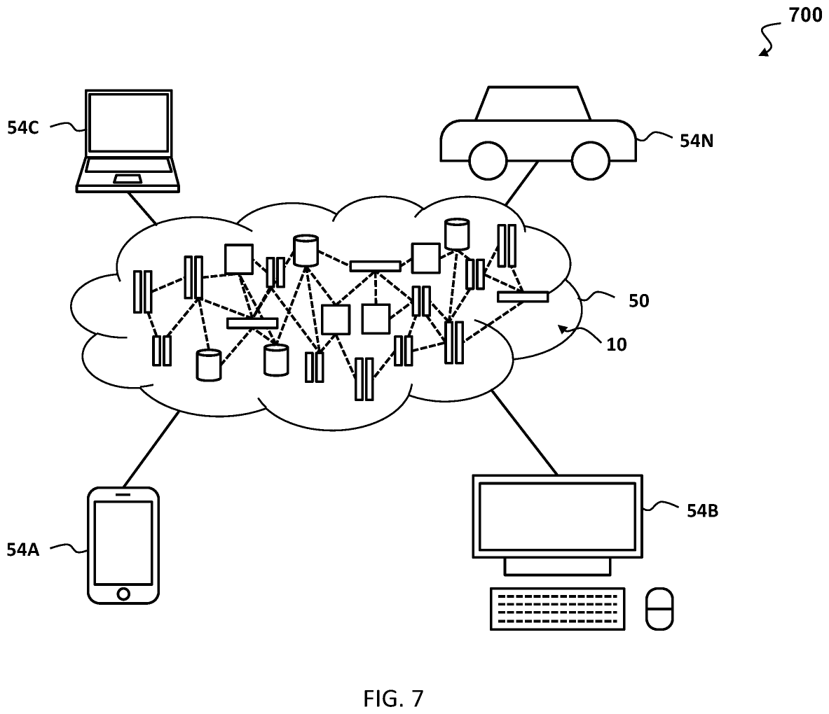

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

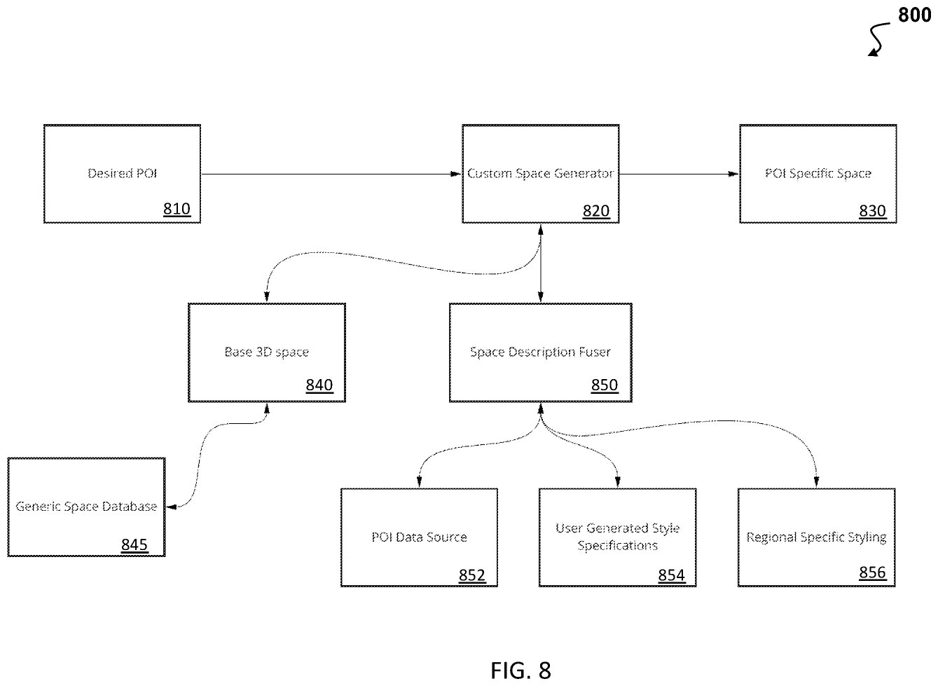

FIG. 8 depicts a functional block diagram of the reality mapper system where the computing device is configured to generate a 3D space for a given POI 800, where the POI may be a public or private space. In one embodiment, a desired POI 810 may be received as input data representing a selected place of interest that is used to generate a 3D virtual space, where the input may be received based on a triggering event, for example, when the virtual world is generated or when a user is walking toward a location in the virtual world that has a physical location counterpart. That is, the desired POI would be the POI that is at the same coordinates in the physical world that would be saved in a POI database. The system may then execute a custom space generator component 820 that takes the desired input and generates a POI specific space 830 to represent a custom virtual space based on input from a base 3D space component 840 and a space description fuser component 850. In this embodiment, the base 3D space component 840 may determine a base 3D space to build on by accessing information about generic spaces from a generic space database 845. For example, the system may take in a 3D model of a restaurant in the form of a stored template layout, and create the 3D virtual model within a virtual engine, where in one embodiment, the 3D virtual model to be displayed may be created within a virtual environment display engine or stored as a 3D file format to be displayed later. The generic space database 845 may store the structure of virtual spaces to build on by using 3D model templates.

In some embodiments, the space description fuser component 850 may receive input data from a number of sources. That is, the space description fuser component 850 may combine POI features, received from a POI data source 852, with styling requirements associated with a user, received from a user generated style specification data source 854, by taking the textures and applying them to 3D models. Additionally, the space description fuser component 850 may adjust model sections that may be adjusted from specifications. For example: A user may need heights of doors adjusted according to their virtual user avatar's height. In another example, the POI data source 852 may provide information regarding the POI, involving data such as cuisines being sold at the restaurant. In one embodiment, the user generated style specification 854 may provide requirements for styling that the user has provided, for example, where the door height needs to be adjusted to accommodate for the size of the avatars. In another embodiment, a regional specific styling 856 may be received as input by the space description fuser component 850 where styling may be provided to a particular region in the virtual space to blend in with the surrounding environment. In one example, such information may be stored as texture files that may then be applied to any 3D Model.

As described, the computing device may execute different components to generate a virtual POI space that reflects a physical POI. As an example, creating a virtual restaurant with the same features as a physical restaurant including its location in the world mirrored in a virtual world. Accordingly, the described components determine a 3D space for a given POI where the generated space reflects a physical POI with styling attributes from the virtual world.

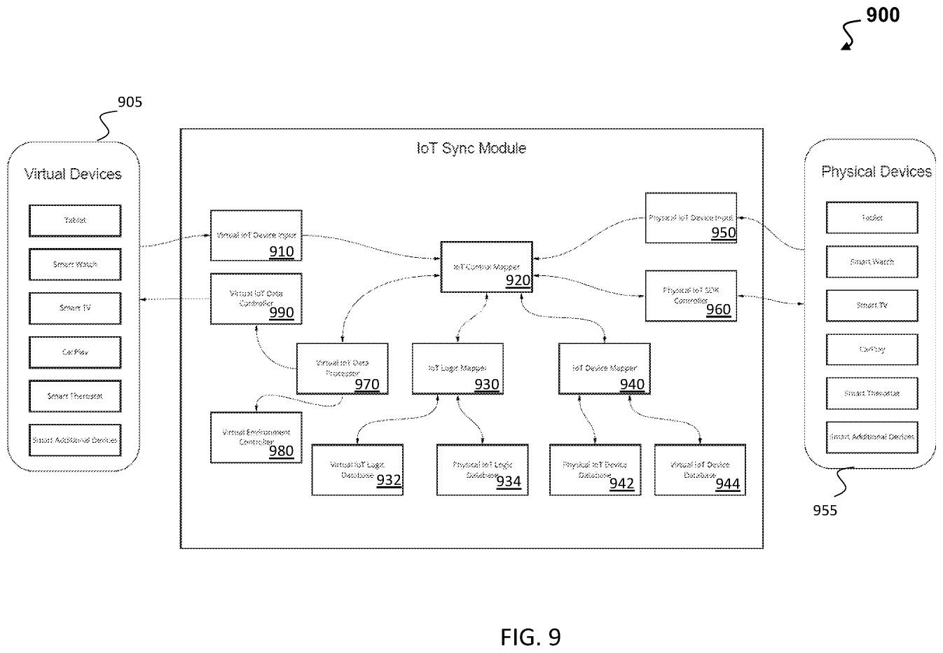

FIG. 9 depicts a functional block diagram of the reality mapper system where the computing device is configured to provide an IoT Sync Module component 900 configured to provide a set of IoT devices that are remaining in sync between the virtual world environment and the physical world environment. For example, a user in the virtual world may be lowering the heat on their virtual home which will then also affect their physical home's temperature. The IoT Sync Module component 900 may receive a virtual IoT device input 910 from a set of virtual devices 905, for example, table, smart watch, smart TV, CarPlay, smart thermostat, or other smart type devices. The input may then be processed by an IoT control mapper component 920 that is configured to map the virtual IoT inputs to physical IoT outputs and vice versa.

The IoT control mapper component 920 may be in communication with a number of different components within the IoT Sync Module component 900. As depicted, an IoT logic mapper 930 may map the virtual logic for a particular IoT device to the physical IoT device logic, where the IoT logic mapper 930 may communicate with a virtual IoT logic database 932 that is configured to store logic for virtual IoT devices and a physical IoT logic database 934 that is configured to store logic for the physical IoT devices. In one embodiment, the type of logic stored may be a set of rules pertaining to how to apply them to each respective world, for example, if a user lowers the temperature by 3 degrees on a thermostat in the physical world, the corresponding virtual IoT logic may be to set the virtual environment display to that same degree decrease while also having been configured to display snow should the temperature be set below 32 degrees. Vice versa, if the user in the virtual world lowers the temperature by 3 degrees, the corresponding physical IoT logic could be to lower the actual thermostat by 3 degrees. Additionally, the IoT control mapper component 920 may be in communication with an IoT device mapper component 940 that may be configured to map the virtual IoT devices to their corresponding physical devices, where the IoT device mapper 940 may communicate with a physical IoT device database 942 that is configured to store the physical IoT devices and a virtual IoT device database 944 that may be configured to store the virtual IoT devices. Further, a physical IoT device input 950 may be received from a set of physical devices 955, for example, smart alarms being turned on, on a physical device. The system may include a physical IoT SDK controller 960 that uses the logic and relevant software development kit (SDK) to control a given IoT setting and issue commands to the physical devices. Since the component would typically have more control over the virtual environment, e.g., weather display, the logic may be more complex in the Virtual IoT Logic DB whereas in the Physical IoT Logic DB the control of the environment may be limited to the SDK of the physical devices.

As part of the synchronization flow, from physical world to virtual world and virtual world to physical world, the IoT Sync Module component 900 may also include a virtual IoT data processor component 970, where that component may receive logic and corresponding devices to issue commands to in the virtual world. The virtual IoT data processor component 970 may provide commands to a virtual environment controller 980 to control any environment settings for the IoT commands, for example, locking doors for a command to turn on the virtual smart alarm system. The virtual IoT data processor component 970 may also communicate with a virtual IoT data controller 990 that may be configured to issue the commands to the virtual IoT devices, for example, the status of a virtual smart alarm system being switched on.

In some embodiments, the databases storing logic and device information collect relevant data as new support for different IoT devices are added, e.g., when a new smart speaker is released, all relevant information for SDK options and software specifications, such as supported format, are added to the databases. The system may then in turn create a virtual counter part of those items that is created to be used in the virtual environment.

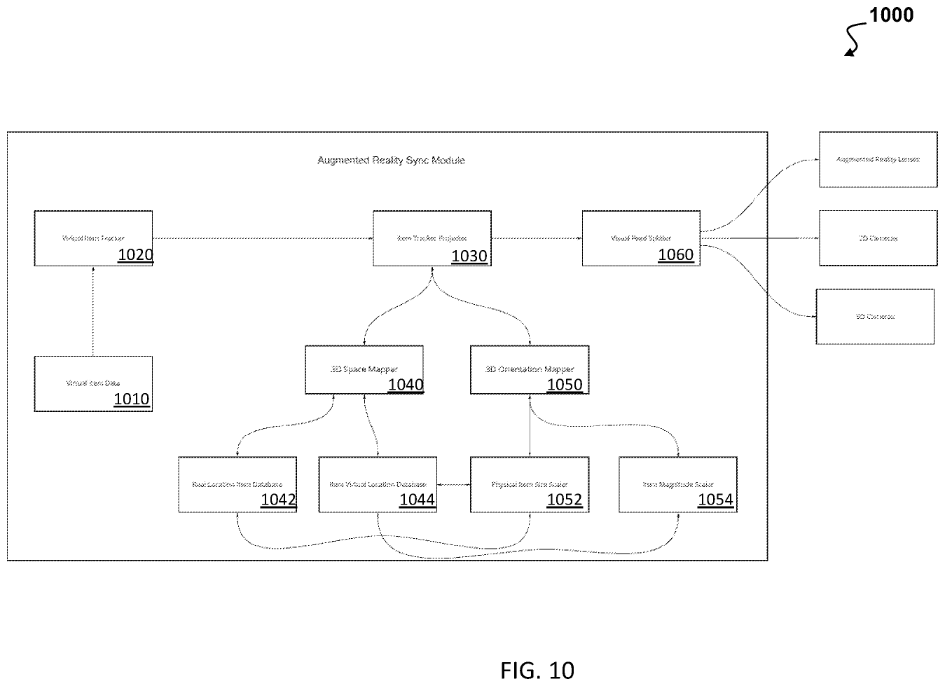

FIG. 10 depicts a functional block diagram of the reality mapper system where the computing device is configured to provide an Augmented Reality Sync Module component 1000, where users in the physical world at a certain location are given the ability to see users in the virtual world via AR lenses in the same location. For example, a person shopping at a Target in San Diego in the physical world may be able to see users shopping at the same Target in the virtual world in San Diego. The Augmented Reality Sync Module component 1000 may receive virtual item data 1010 and use a virtual item tracker 1020 where the virtual item tracker 1020 may be configured to take in the virtual item information and extract the needed information for tracking the item, such as location. In one embodiment, the virtual item may be an avatar or an item. The system may include an item tracker projector 1030 in communication with a 3D space mapper 1040 and a 3D orientation mapper 1050, where the item tracker projector 1030 may be configured to use data input from the 3D space mapper 1040 and the 3D orientation mapper 1050 to place virtual items in the physical world that may be seen by visual systems. In one embodiment, the item tracker projector 1030 may be configured to determine a mapping that needs to be done from a flat map to a 3D map since the virtual world and the physical world may not necessarily exist with the same coordinate system. That is, the physical world is considered a globe with latitude and longitude, while the virtual world can be a flat plan with x,y coordinates (mimicking latitude and longitude). Accordingly, a 2D environment needs to be projected onto a 3D space and vice versa using any of the several known projection algorithms. The 3D space mapper 1040 may be configured to take virtual item location information and physical item locations to find mapping between the two by using a predefined 2D x,y coordinates to a latitude/longitude via a conversion algorithm. To accomplish this, the 3D space mapper 1040 may in turn be in communication with a real location item database 1042 that may be a database storing real item locations, for example, information about physical items such as its latitude and longitude. The 3D space mapper 1040 may also be in communication with an item virtual location database 1044 which is a database for storing virtual item locations.

As described herein, the 3D orientation mapper 1050 may be in communication with a physical item size scaler 1052 and item magnitude scalar 1054. In one embodiment, the physical item size scaler 1052 may be configured to appropriately scale items, using the virtual item by removing adjustments users may have made, e.g., a user increasing scale of TV size, and then converting a set of virtual measurements, e.g., height, width, and depth, into proper physical measurements, e.g., Metric system. The 3D orientation mapper 1050 may also be in communication with an item magnitude scaler 1054 that may be configured to scale magnitudes of virtual items using information about the current tracked item such as its movement velocity and direction. The 3D orientation mapper 1050 may be configured to use the size and magnitude scalers to orient virtual items in the physical space by adjusting the size with physical item size scaler 1052 and applying magnitude of an item with the item magnitude scalar 1054.

Additionally, the item tracker projector 1030 may be configured to determine location and position of a set of virtual items based on the physical world locations, and transmit the determined location and position to a visual feed splitter component 1060. The visual feed splitter component 1060 may be configured to take the physical locations of virtual items and split the feed for different formats. For different display systems, the visual feed splitter component 1060 would need to display in a different format, for example, with an augmented reality visual display, the image feed would need to be in a 360 degrees format so that orientation is appropriately applied to the lenses while for a 2D display, it may be sufficient to take a static mpg file that only can see a portion of the virtual world and cannot display the rest of the environment, e.g., a fixed birds eye view of a same corresponding street on a TV screen. In one embodiment, the visual feed splitter component 1060 may then send the feed associated with each device to be displayed by a set of one or more visual systems, e.g., augmented reality lenses, 2D cameras, 3D cameras.

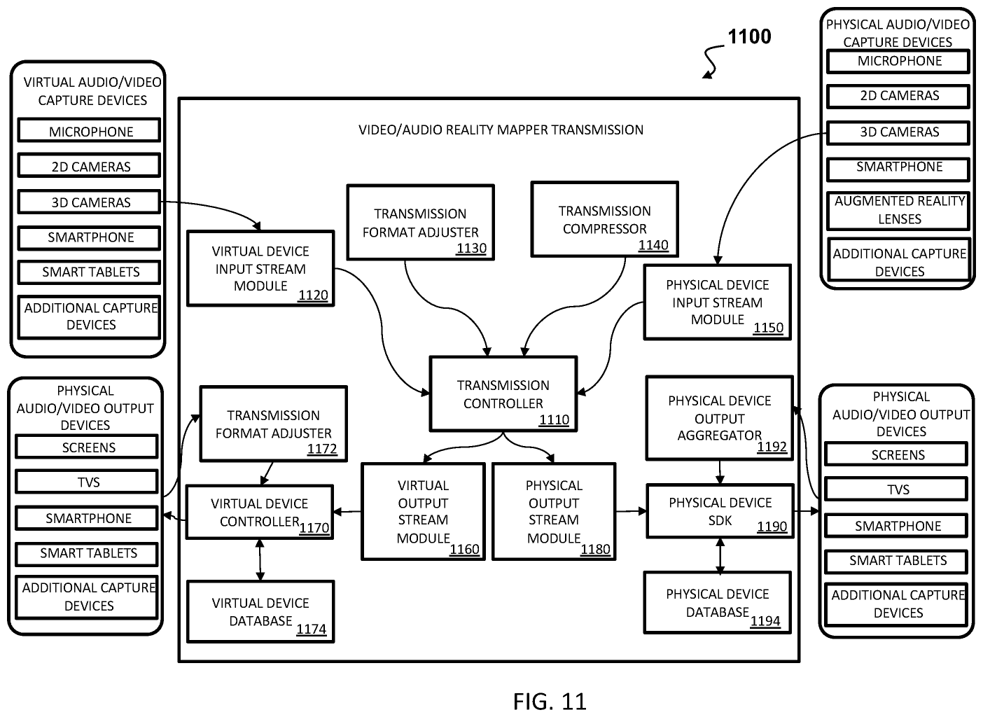

FIG. 11 depicts a functional block diagram of a Video/Audio Reality Mapper Transmission component 1100 of the reality mapper system which is configured to allow transmission of data from the physical world to the virtual world and vice versa. For example, a user in virtual New York Times Square can talk using virtual cameras to stream to physical digital billboards location in the physical New York Times Square and vice versa. In such embodiments, all databases storing logic and device information may be collected as new support for different IoT devices are added, e.g., when a new smart speaker is released, all relevant information for SDK options and software specifications such as supported formats are added to the databases. Those items also have a virtual counterpart that is created to be used in the virtual environment. At the heart of the Video/Audio Reality Mapper Transmission component 1100 may be a Transmission Controller 1110 configured to manage the video/audio transmissions from the virtual world to the physical world and vice versa. As depicted, the Transmission Controller 1110 may be in communication with a number of other components and receive several different inputs. In one embodiment, input may be received from a Virtual Device Input Stream Module 1120 which may be configured to receive the virtual input data that is to be streamed to the physical world, from a number of Virtual Audio/Video Capture Devices, such as Microphone, 2D camera, 3D camera, Smartphone, Smart Tablet, etc.

A Transmission Format Adjuster 1130 may be used to format the data to be transmitted to its physical/virtual counterpart, while a Transmission Compressor 1140 may be used to compress the data that is to be transmitted. A Physical Device Input Stream Module 1150 may be configured to provide an input data stream that is receiving data to transmit to the virtual world.

A Virtual Output Stream Module 1160 may be configured to aggregate available virtual devices to be used for transmission. For example, in a virtual world the New York Times Square could use all of the available digital billboards. The Virtual Output Stream Module 1160 may be receiving data from a Virtual Device Output Aggregator 1172 that aggregates available virtual devices to be used for transmission. A Virtual Device Database 1174 may be used to store information about virtual devices and be accessible by a Virtual Device Controller 1170 configured to control the virtual devices to stream video and audio.

Additionally, a Physical Output Stream Module 1180 may use transmission from the controller to stream data to a set of physical devices. A Physical Device SDK 1190 may provide SDKs to control the physical devices to stream audio and video while accessing a Physical Device Database 1194 that may store information about physical devices. The system, in one embodiment, may also use a Physical Device Output Aggregator 1192 to aggregate available physical devices to be used for transmission. For example, in the New York Times Square virtual environment, the system could use all of the available digital billboards.

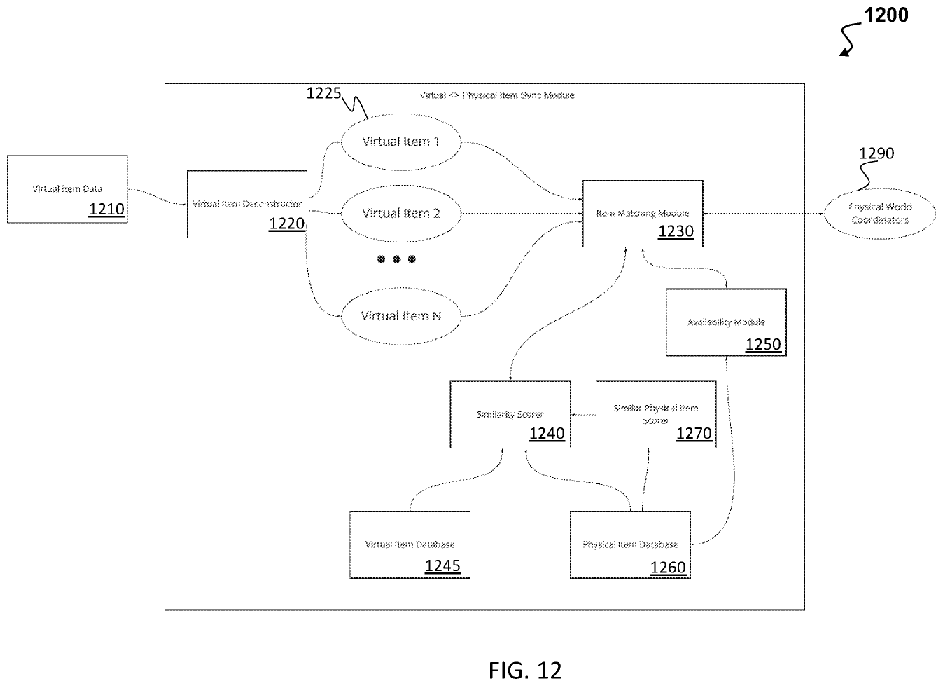

FIG. 12 depicts a functional block diagram of the Virtual < > Physical Item Sync Module component 1200 where in one embodiment, the system may synchronize a virtual item and a physical item by ensuring that for a given virtual item, there is a corresponding physical item and vice versa. The system may include a sync module that receives virtual item data 1210 as input and generates a set of physical world coordinators 1290 as an output. The sync module may comprise a virtual item deconstructor component 1220 and an item matching component 1230.

The virtual item deconstructor component 1220 may generate a set of virtual items 1225 based on the received virtual item data 1210 via splitting each virtual item into different subcomponents that more accurately mimic the physical world. The virtual item deconstructor component 1220 may perform this task by using the virtual item metadata. In one embodiment, whenever a virtual item is combined within the virtual world, the original components are stored as metadata so that they may later be deconstructed. In one example of the virtual world, a user may have a standing desk that can float. According to the disclosed embodiments, the system may then split up the standing desk that is floating into a standing desk and floating device which more accurately represents the physical world.

The item matching component 1230 may then match the received generated set of virtual items to a physical item based on similarity and which items are available in the physical world. In one embodiment, the matching may be performed based on a received similarity score from a similarity scorer component 1240 and an availability status of the physical item from an availability component 1250. The availability component 1250 may determine the availability status of the physical item using collected information from third parties, e.g., if an Amazon® item can be purchased or not. The data may be collected in the form of third party API's, web scraping, and RSS feeds that are stored in a database and updated at a predefined time interval. In one embodiment, a physical item database 1260 may provide the updated information for the items having an availability status to the availability component 1250, via push action (where the server pushes communications where the request for a given transaction is initiated by the server) or alternatively, based on a lookup request sent to the physical item database. In one example, the availability status may be stored as a flag using I/O and updated on an as-needed basis or in real-time.

In one embodiment, the similarity scorer component 1240 may determine the similarity score based on receiving information from the virtual item database 1245 and the physical item database 1260 where the similarity scorer component 1240 may also use similarity data related to the physical item, received from a similarity physical item scorer 1270. Accordingly, the similarity scorer 1240 may receive input data information from the virtual item database 1245, physical item database 1260, and the similarity physical item scorer 1270 to determine the similarity score via using fields such as name, descriptions, sizing, details information, if images are available; this process may also use machine learning (ML) techniques such as image similarity determined by a deep learning model. In one embodiment, the virtual item database 1245 may provide information such as 3D model, item ownership, virtual modifications, name, features, price, labels, keywords, images, location, orientation, etc. In another embodiment, the physical item database 1260 may provide information such as name, features, price, labels, keywords, images, location, orientation, etc.

The similarity physical item scorer 1270 may output similar physical items relating to the item in question, using information from the physical item database 1260. Upon determining a set of valid candidates, the component may be configured to provide the relevant physical items to the similarity scorer component 1240 for the similarity scorer component 1240 to determine scores for the virtual items/physical item pairs, whether there are exact or similar matches. That is, the item matching component 1230 may use the received similarity score and the availability status of the physical item received from the availability component 1250, to determine the physical world coordinates. The system may then use the relevant physical item data, for example, delivery providers and/or order fulfillment information, to proceed with any physical transactions. Accordingly, the system may be configured to synchronize a virtual and physical item by ensuring that for a given virtual item, there is a corresponding physical item and vice versa.

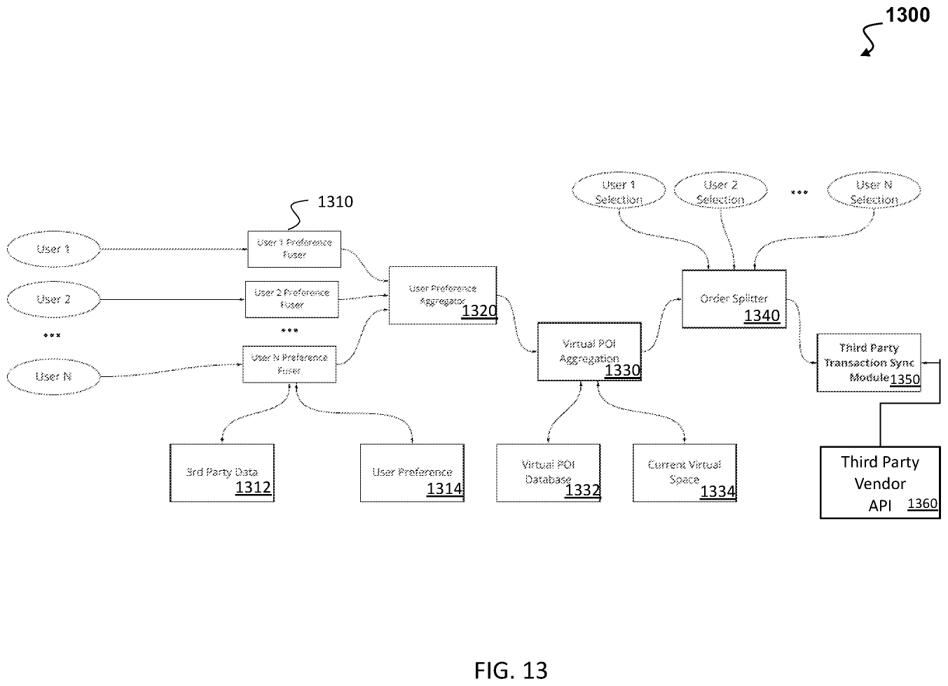

FIG. 13 depicts a functional block diagram of the reality mapper system for Group Virtual Aggregation for Third Party Transactions 1300. In this embodiment, the system is configured to take in a group of user preferences to create a transaction that is an aggregate of all user preferences. For example, a group of people ordering food at a restaurant would have a final order being something that all the users prefer. Accordingly, for a set of users, an associated user preference is being received as input, indicating the preferences of each user, for example, a user is vegan. In one embodiment, via the user preference fuser 1310, the system may be configured to create user personalization features by taking in the user preferences 1314 and third party data 1312 to create a defined user profile store that can be used to be compared against when making selections. In one example, third party data may be data from outside of the system that is used for personalized space.

A user preference aggregator 1320 may then receive the set of user preferences and personalized features to group in the personalization features from each user and create the personalization aggregate by using deep learning collaborative filtering. For example, if user 1 likes pizza, user 2 likes spaghetti, and user 3 likes calzone, the group aggregate would be a preference to Italian food. The aggregated user preferences may then be transmitted to a virtual POI aggregation component 1330 that is configured to use group personalization and available POI information to aggregate customized POI's, which the users may then interact with and create transactions from. In another example, this could be a McDonalds® and Burger King® Hybrid restaurant where the user can order selections from both restaurants. This determination may be made based on the Virtual POI Database 1332, which stores all virtual POI collected from web scraping or third party APIs, and Current Virtual Space 1334, which may use surrounding virtual environment as constraints for the virtual POI Aggregation. The system may then use an order splitter component 1340 to split up the customized POI transactions into their corresponding physical transactions. For example, the virtual aggregations may have selections from McDonalds and Burger King, the Order splitter 1340 would then create those respective orders that are separate to send to. A third party transaction sync module component 1350 may then receive the order and using a third party vendor API 1360, create and synchronize the third party transactions, such as food delivery.

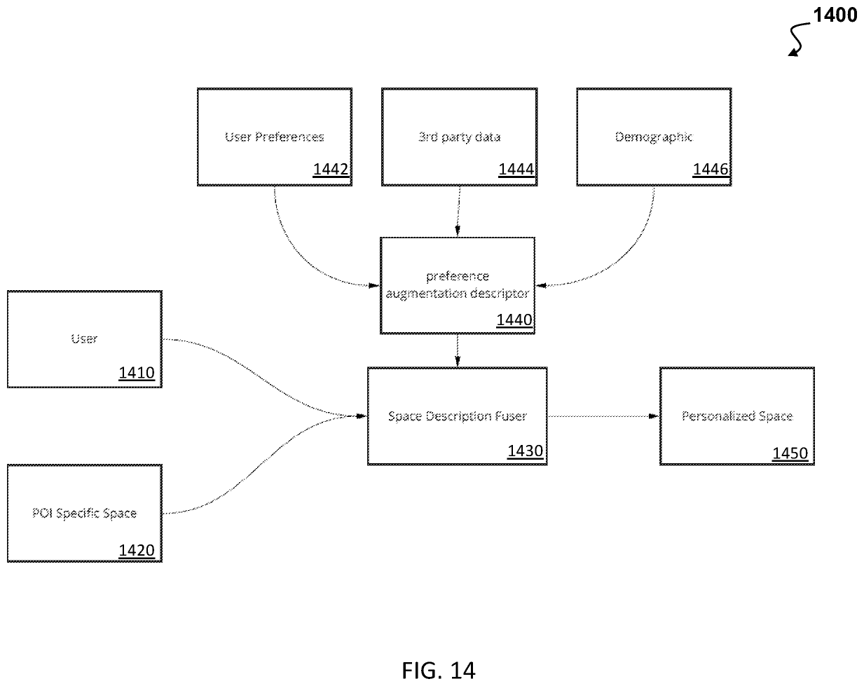

FIG. 14 depicts a functional block diagram of the reality mapper system to customize a POI space for a user 1400. More specifically, to customize a POI space for a user based on user preferences, the component may be configured to create a customized version of a physical POI that is personalized to a user. To do that, the component may receive as input, the user information 1410 that the POI space is being generated for and POI specific space information 1420 related to the physical POI that is being used as the original data source. In one embodiment, a space description fuser 1430 may receive user information 1410, POI specific space information 1420, along with input from the preference augmentation descriptor 1440 and be configured to combine POI features with styling requirements from the user by taking the textures and applying them to 3D models, and thereafter adjusting model sections which may be adjusted from a set of specifications. In one embodiment, the space description fuser 1430 may first take the user avatar and determine sizing constraints and appropriately size 3D models of the POI. The space description fuser 1430 may also take in user preferences such as color, a previously liked texture, e.g., user wears virtual clothing with certain textures, and apply those textures to the model. For example, a user may need heights of doors adjusted according to a virtual user avatar and associated height. Also, the space description fuser 1430 may use predefined rules that may be generated from personalization features by taking fields such as diet dislikes, and automatically removing any text matching that content from the POI that will be used for 3D model generation. That is, the system would be configured to remove, for example, burgers from a text menu that will be turned into a 3D menu within the POI space.

A preference augmentation descriptor component 1440 may also provide input to the space description fuser 1430 by determining a description using all known personalization features by applying user preference textures that may be applied to 3D objects, as well as defined fields. Third (3rd) party data such as likes and dislikes of certain POI options, e.g., user in the past disliked burgers, may also be taken as input. These inputs may be represented in more detail as user preferences 1442 data where they represent preferences a user has stored as a mapping of defined fields, for example, a user has a vegan diet. User preferences 1442 data may also include user preferred textures, for example, applying 2D texture of their physical home to wallpaper in the virtual house, wearing certain patterns of virtual clothing, etc. The 3rd Party Data 1444 may be data obtained outside of the system that may be used for personalized space. Demographic 1446 data may be the personalization features a user has in common with a subset of other users. That is, by gathering information about the preferences of other users in similar categories, such as, age, race, location, education, nationality, religion, and ethnicity, the system may use ML techniques to more accurately predict outcomes. Using the received data from the preference augmentation descriptor 1440, the space description fuser 1430 may generate a personalized space 1450 associated with a customized space that is created, for example, A BBQ restaurant that only serves vegan food since the user is vegan.

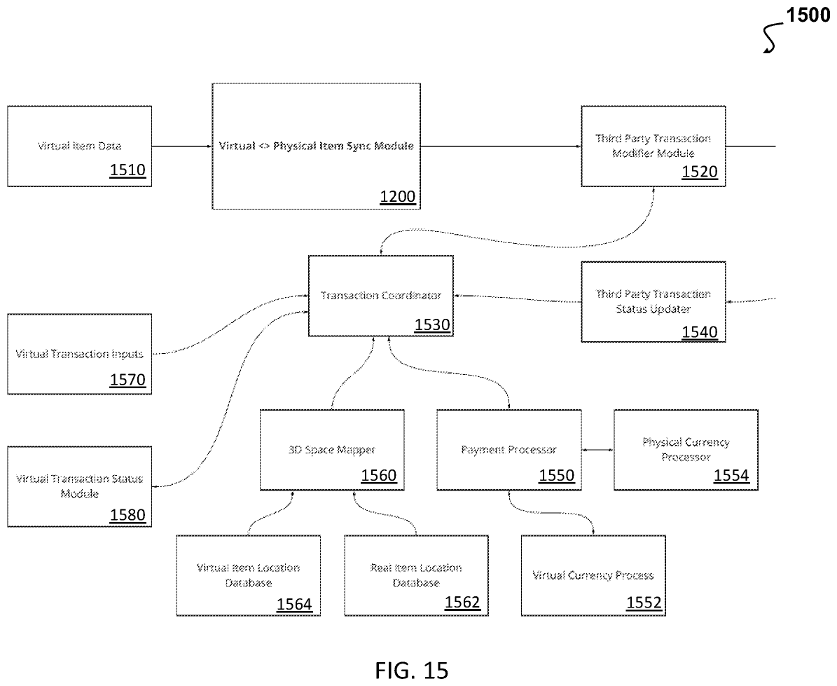

FIG. 15 depicts a functional block diagram of a Third Party Transaction Sync Module 1500 component of the reality mapper system. The Third Party Transaction Sync Module 1500 component may be configured to create and synchronize transactions between the virtual world and physical world. One example of such transaction is a user ordering food from Uber Eats® within the virtual world. The order will then get delivered in the virtual world with a driver just like it does in the physical world. In one embodiment, virtual item data 1510 may be received as input by the Virtual < > Physical Item Sync Module component 1200 (see FIG. 12) which may be configured to ensure virtual and physical items are properly in sync. For example, in the virtual world there may be food options that are combinations of physical real food options. Once this check happens, data may then be provided to a third party transaction modifier module 1520 which modifies third party transactions with available information provided by a transaction coordinator 1530. The transaction coordinator component 1530 may receive multiple inputs and be configured to use third party data to keep the virtual world in sync with physical updates as well as created initial transactions.

The disclosed embodiments provide a Third Party Transaction Status Updater 1540 that may use third party APIs to receive any updates about transactions and send them to the transaction coordinator 1530. Additionally, a Payment Processor 1550 may take user payments, which may be a virtual currency processor 1552 or physical currency processor 1554, and create physical transactions using currency needed by third parties. In these embodiments, the Physical Currency Processor 1554 may process Physical currencies, for example, PayPal® transactions and the Virtual Currency Processor 1552 may process virtual currencies, for example, virtual currencies, that the user may have in the virtual world.

In another embodiment, a 3D space mapper 1560 may be configured to take virtual item location information and physical item locations to find mapping between the two by using a predefined 2D x,y coordinates to a lat/long with a conversion algorithm. The 3D space mapper 1560 may be in communication with a Real Item Location Database 1562 that stores information regarding locations of physical items and with a Virtual Item Location Database 1564 that stores information regarding locations of virtual items. In another embodiment, Virtual Transaction Inputs 1570 may be received by the transaction coordinator 1530 to use user inputs that occur within the virtual world, for example, a user turning around the virtual delivery driver car. Additionally, a Virtual Transaction Status Module 1580 may also communicate with a transaction coordinator 1530 and be configured to keep the corresponding virtual items, that reflect physical third party transaction status, up to date by using the new location of items as determined by the 3D Space Mapper.

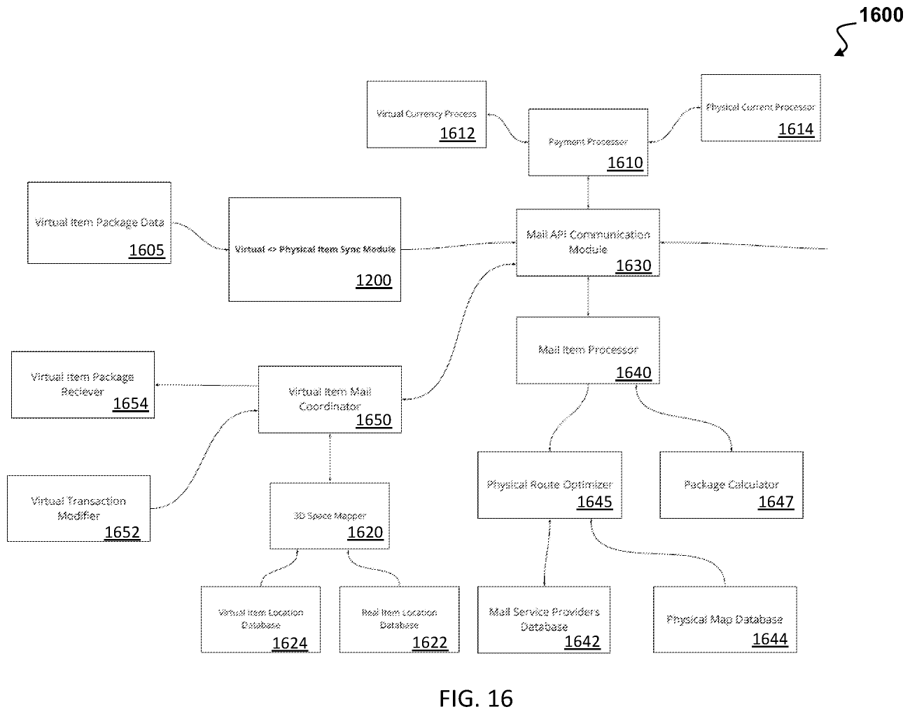

FIG. 16 depicts a functional block diagram of a Mail Service Transaction Sync Module 1600 component of the reality mapper system. The Mail Service Transaction Sync Module 1600 may be configured to create and synchronize mail transactions between the virtual world and physical world. For example, a user can mail a package of clothing in the virtual world and the same clothing package can be sent in the physical world. This component may use the Virtual < > Physical Item Sync Module 1200 (see also 1200 in FIG. 12) that ensures virtual and physical items are properly in sync and receives virtual item package data 1605. For example, in the virtual world there may be food options that are combinations of real physical food options.

Additionally, a Payment Processor 1610 may take user payments which may be virtual or physical money and create physical transactions using currency needed by third parties. The Payment Processor 1610 may be in communication with a Physical Currency Processor 1614 that processes physical currencies, for example, PayPal® transactions and a Virtual Currency Processor 1612 that processes virtual currencies, for example, virtual currencies that a user may have in the virtual world.

Input may be received by the Mail Service Transaction Sync Module 1600 component from a Real Item Location Database 1622 that stores information regarding locations of physical items and a Virtual Item Location Database 1624 that stores information regarding locations of virtual items. These inputs may be received by a 3D Space Mapper component 1620 that receives virtual item location information and physical item locations to determine a mapping between the two by using a predefined 2D x,y coordinates to a lat/long with a conversion algorithm.

A Mail API Communication Module 1630 may communicate with a mail service to send the routing and package information. The Mail API Communication Module 1630 may also be in communication with a Mail Item Processor 1640 that creates the package and route information to send to the communication module by using predefined rules defined by mail services, e.g., if contents of a package are a certain substance, then use a specific package material. A Physical Route Optimizer 1645 uses a Physical Map database 1644 to create routes to deliver the package in the physical world by using which Mail Service Providers that are available for specific routes. The Mail Service Providers Database 1642 provides available information for mail providers such as regions that are supported for delivery. This may be information that is scraped from the web or available via mail provider APIs. The Physical Map Database 1644 may have available physical world map and routes information, which may be collected via third party mapping APIs or scraped from the web. An additional component may be the Package Calculator 1647 that calculates the required package information such as size, weight, and price by taking any data available from the virtual item to create the necessary data format to fill out the package requirements.

In one embodiment, there may also be a corresponding Virtual Item Mail Coordinator 1650 that uses mail service data from the Mail API Communication Module 1630 to coordinate package locations. The Virtual Item Mail Coordinator 1650 also takes in any modifications in order to send the data to the Mail API Communication Module 1630 for transaction updates. For example, when a user updates the delivery time constraints. A Virtual Transaction Modifier 1652 may receive user modifications from the virtual environment for information such as updates in needed delivery time. A Virtual Item Package Receiver 1654 keeps the virtual packages in sync with the physical package locations by using a conversion algorithm of lat/long coordinates to x,y locations within a virtual world.

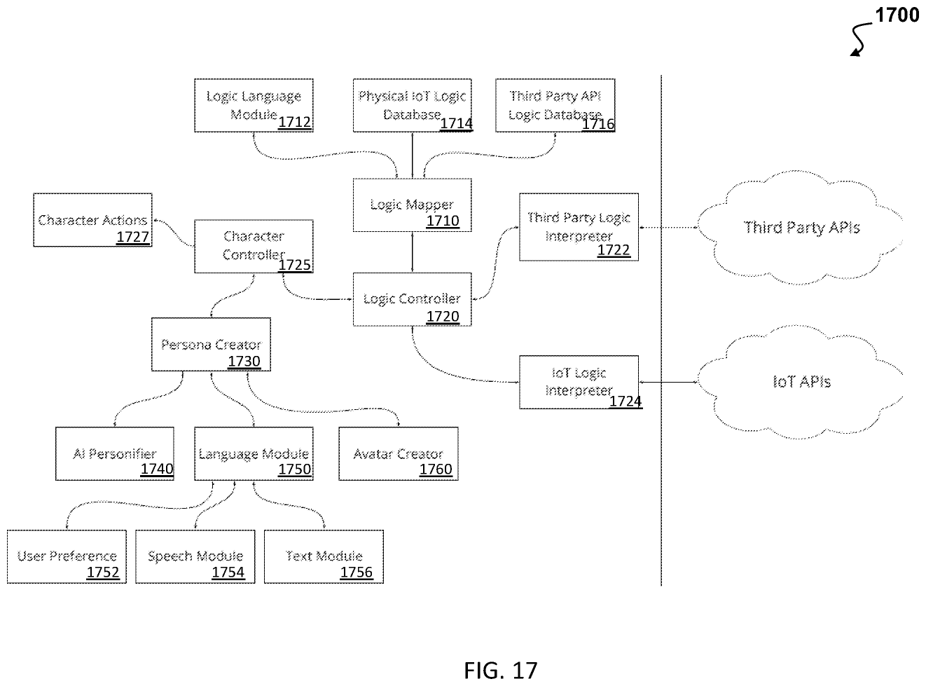

FIG. 17 depicts a functional block diagram of a Persona Embodiment of Physical Reality 1700 component of the reality mapper system. The Persona Embodiment of Physical Reality 1700 component may create a non-player character (NPC) that embodies physical reality. For example, the component may create a character that represents an alarm clock so that whenever the alarm goes off, instead of a ringing device, the character tells the user about the alarm time in the virtual world. A Logic Mapper 1710 may be configured to map the third party physical logic to the representation that a character must convey by taking rules that are defined by different integrations. For example, a Twitter® notification may be turned into the logic of notifying a user that their Twitter profile has received a notification. The Twitter notification may be turned into logic Action=NOTIFY, provider=Twitter. The Logic Mapper 1710 may be in communication with a Logic Language Module 1712 that may be configured to parse out IoT logic into language by taking logic and using a deep learning language generation model. The Logic Mapper 1710 may also be in communication with a Physical IoT Logic Database 1714 that stores the known logic for IoT devices, along with a Third Party API Logic Database 1716 that stores known logic for third party APIs.

The Logic Mapper 1710 may also be in communication with a Logic Controller 1720 that uses the Logic Mapper 1710 and incoming logic from APIs to create language that can be used by character persona. One such example is a Third Party Logic Interpreter 1722 that takes in events from Third Party APIs and converts them to logic, for example, the event of a Twitter notification can be turned into an alert to notify a user of a Twitter update. Additionally, an IoT Logic Interpreter 1724 may be used that takes in events from IoT devices and converts them to logic. For example, a Smart Alarm going off can be the logic of notifying a user that an alarm is going off.

A Persona Creator 1730 may be utilized to create the Character by combining the Persona, Language Module, and Avatar. In one embodiment, a Character Controller 1725 may be in communication with the Persona Creator 1730 and Logic Controller 1720 in order to create as output, a set of Character Actions 1727. The Personal Creator 1730 may be in communication with an Avatar Creator 1760 that generates the 3D avatar using procedural generation, and an AI Personifier 1740 which adds personality to the character by using ML algorithm for emotion mimicking. The Persona Creator 1730 may also be in communication with a Language Module 1750 where the module is responsible for setting the language/speech and text patterns based on user preferences, and the language Module 1750 may communicate with: a Speech Module 1754 that provides available speech modules, e.g., ASR in German; a Text Module 1756 that provides available text modules, e.g., Character writing in Spanish; and User Preference 1752 that takes into account the user language/speech settings.

In the above disclosed embodiments, the user device may be any type of display system providing a view through optics so that the generated image that is being displayed to the user is overlaid onto a real-world view. Thus, as a wearable display system, an augmented reality device can incorporate components, such as processing unit(s), computer interface(s) that provide network connectivity, and camera(s) etc. These components can be housed in the headset or in a separate housing connected to the headset by wireless or wired means. The user device may also include an imaging application implemented to generate holograms for display. The imaging application may be implemented as a software application or components, such as computer-executable software instructions that are executable with the processing system. The imaging application may be stored on computer-readable storage memory (e.g., the memory), such as any suitable memory device or electronic data storage implemented in the alternate reality device.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above. The present embodiments are, therefore, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method comprising:
generating, by a computing device having a processor and addressable memory, a 3D virtual space for a given point of interest (POI);
determining whether a set of user preferences are available within the generated 3D virtual space and customize the 3D virtual space based on the availability of the set of user preferences;
determining a generated 3D environment based on the customized 3D virtual space and availability of the set of user preferences, wherein determining the generated 3D environment is further based on receiving data from a set of components and executing at least one of:
an Internet of Things (IoT) sync component, wherein the IoT sync component is executed based on receiving physical/virtual input via checking for IoT input;
an augmented reality sync component, wherein the augmented reality sync component is executed based on receiving new augmented reality input via checking for augmented reality transmission data;
a video/audio reality mapper transmission component, wherein the video/audio reality mapper transmission component is executed based on receiving new video/audio transmission via checking for video/audio transmission data;
a virtual and physical item sync component, wherein the virtual and physical item sync component is executed based on receiving new virtual and physical item via checking for virtual and physical item data, wherein the virtual and physical item sync component is further based on receiving data from at least one of:
a mail transaction sync component, wherein the mail transaction sync component is executed based on receiving new mail and third party data that comprise mail data based on checking for mail and third party data; and
a third party transaction sync component, wherein the third party transaction sync component is executed based on receiving new mail and third party data that comprise third party data based on checking for mail and third party data; and
a persona embodiment of physical reality component, wherein the persona embodiment of physical reality component is executed based on if a user setting for persona embodiment is enabled via checking for embodiment notifications; and
updating the generated 3D environment to customize the 3D virtual space for a user based on the received data from at least one of the components from the set of components, and wherein the set of components are being continuously executed in real-time thereby syncing the functions of a set of devices present in a virtual world environment with a set of devices present in a physical world environment.

2. The method of claim 1, wherein the IoT sync component is configured to provide a set of IoT devices that are remaining in sync between the virtual world environment and the physical world environment.

3. The method of claim 1, wherein the augmented reality sync component is configured to provide users in the physical world environment at a certain location, the ability to see users in the virtual world environment via AR lenses in the same location.

4. The method of claim 1, wherein the video/audio reality mapper transmission is configured to allow transmission of data from the physical world environment to the virtual world environment and vice versa.

5. The method of claim 1, wherein the virtual and physical item sync component is configured to ensure virtual items in the virtual world environment and physical items in the physical world environment are properly in sync.

6. The method of claim 5, wherein the virtual and physical item sync component is configured to synchronize a virtual item and a physical item by ensuring that for a given virtual item, there is a corresponding physical item and vice versa.

7. The method of claim 1, wherein the third party transaction sync component is configured to create and synchronize transactions between the virtual world environment and the physical world environment.

8. The method of claim 1, wherein the mail transaction sync component is configured to synchronize mail transactions between the virtual world environment and the physical world environment.

9. The method of claim 8, wherein the user mails a package of items in the virtual world environment and a package of the same items is sent in the physical world environment.

10. The method of claim 1, wherein the persona embodiment of physical reality component is configured to create a non-player character (NPC) that embodies physical reality.

11. The method of claim 1, wherein user preferences are used to provide a customized 3D virtual space version of a physical POI that is personalized to the user.

12. A computing device having a processor and addressable memory, the processor configured to execute a set of components comprising:
an Internet of Things (IoT) sync component, wherein the IoT sync component is executed based on receiving physical/virtual input via checking for IoT input;
an augmented reality sync component, wherein the augmented reality sync component is executed based on receiving new augmented reality input via checking for augmented reality transmission data;
a video/audio reality mapper transmission component, wherein the video/audio reality mapper transmission component is executed based on receiving new video/audio transmission via checking for video/audio transmission data;
a virtual and physical item sync component, wherein the virtual and physical item sync component is executed based on receiving new virtual and physical item via checking for virtual and physical item data, wherein the virtual and physical item sync component is further based on receiving data from at least one of:
a mail transaction sync component, wherein the mail transaction sync component is executed based on receiving new mail and third party data that comprise mail data based on checking for mail and third party data; and
a third party transaction sync component, wherein the third party transaction sync component is executed based on receiving new mail and third party data that comprise third party data based on checking for mail and third party data;
a persona embodiment of physical reality component, wherein the persona embodiment of physical reality component is executed based on if a user setting for persona embodiment is enabled via checking for embodiment notifications;
wherein the computing device is further configured to:
generate a 3D virtual space for a given point of interest (POI);
determine whether a set of user preferences are available within the generated 3D virtual space and customize the 3D virtual space based on the availability of the set of user preferences;
determine a generated 3D environment based on the customized 3D virtual space and availability of the set of user preferences, wherein the generated 3D environment is further determined based on receiving data from the set of components being executed; and
update the generated 3D environment to customize the 3D virtual space for a user based on the received data from at least one of the components from the set of components, and wherein the set of components are being continuously executed in real-time thereby to sync the functions of a set of devices present in a virtual world environment with a set of devices present in a physical world environment.

13. The computing device of claim 12, wherein the set of components further comprises:
a component to group virtual aggregation for third party transactions.

14. The computing device of claim 13, wherein the component to group virtual aggregation for third party transactions is configured to take in a group of user preferences to create a transaction that is an aggregate of all user preferences.

15. The computing device of claim 14, wherein the component to group virtual aggregation for third party transactions is connected to the third party transaction sync component to transmit the created transaction that is an aggregate of all user preferences.
